(19) United States
(12) Patent Application Publication
(10) Pub. No.: US 2006/0171432 A1
(43) Pub. Date: Aug. 3, 2006

(54) Optical beam output controller and optical disk device

(75) Inventor: Toru Nagara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/320,722

(22) Filed: Dec. 30, 2005

(30) Foreign Application Priority Data
Jan. 12, 2005 (JP) 2005-005455

(51) Int. Cl. H01S 3/00

(52) U.S. Cl. 372/38.07

(57) ABSTRACT

The present invention enables to stably output an optical beam. The present invention provides an upper limit value comparator for comparing a low bandwidth signal according to an output intensity of an optical beam emitted to an optical disk in the case of reproducing data from the optical disk with an upper limit value, a lower limit value comparator for comparing the low bandwidth signal with the lower limit value smaller than the upper limit value, and an up-down counter for decreasing the counter value from the counter value immediately before when the low bandwidth signal is larger than the upper limit value, increasing the counter value from the counter value immediately before when the low bandwidth signal is smaller than the lower limit value and holding the counter value at the counter value immediately before when the low bandwidth signal is smaller than the upper limit value and larger than the lower limit value.

### CROSS REFERENCE TO RELATED APPLICATIONS

The present invention contains subject matter related to Japanese Patent Application JP 2005-005455 filed in the Japanese Patent Office on Jan. 12, 2005, the entire contents of which being incorporated herein by reference.

### BACKGROUND OF THE INVENTION

1. Field of the Invention

The present invention relates to an optical beam output controller and an optical disk device, and is suitable to be applied for, for example, an optical disk device for controlling to output a laser beam emitted to an optical disk.

2. Description of the Related Art

Optical disk devices in which data is recorded on an optical disk, such as, a Blu-ray disk (Registered Trademark), etc., and the data are reproduced from the optical disk, are in widespread use.

When data is recorded on the optical disk and the data is reproduced from the optical disk, the optical disk device can stably record and reproduce data by emitting laser beams regulated in predetermined output intensity to the optical disk.

For this purpose, the optical disk device receives a part of the laser beam emitted from, for example, a laser diode by a photodetector for monitoring, and controls to feed back the output intensity of the emitting laser beam according to the intensity of the laser beam received at this time. Further, recently, an optical disk device which is adapted to digitally control the output intensity of a laser beam by using an up-down counter, is proposed.

In this case, the optical disk device is adapted to control the output intensity of the laser beam based on the output value by comparing an intensity signal proportional to the output intensity of a laser beam with a predetermined reference value, increasing (up) or decreasing (down) the output value of the up-down counter according to the comparison result at this time from the output value immediately before, and controlling the output intensity of the laser beam based on the output value [for example, refer to Jpn. Pat. Appln. Laid-Open Publication No. 2000-339736 (FIG. 1, page 8)].

### SUMMARY OF THE INVENTION

However, in an optical disk device of such a configuration, an up-down counter increases or decreases an output value of immediately before, to generate next output value. Accordingly, even if the output intensity of a laser beam is in a suitable state regulated to be a substantially desired value, the output value is always increased or decreased. As a result, the output intensity of the laser beam is fluctuated.

In such a case, the optical disk device emits the laser beam fluctuated in its output intensity to an optical disk. Accordingly, recording of data on the optical disk and reproducing of the data from the optical disk cannot be stabilized. Therefore, there is a problem that recording and reproducing accuracies are deteriorated.

The present invention has been made in consideration of the above-described points, and proposes an optical beam output controller which can stably output an optical beam and an optical disk device which can improve the recording and reproducing accuracies of data with respect to the optical disk.

To solve the problems above, the optical beam output controller according to one embodiment of the present invention controls an output intensity of an optical beam emitted on the optical disk when data is written to the optical disk or data is read from the optical disk. The optical beam output controller includes an upper limit value comparing means for comparing an intensity signal according to an emitting intensity of the optical beam with a predetermined upper limit value, a lower limit value comparing means for comparing the intensity signal with a predetermined lower limit value smaller than the upper limit value, and an output value control means for decreasing an output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

Thus, when the intensity signal is smaller than the upper limit value and larger than the lower limit value, the output value is held by the output value control means. Accordingly, the output intensity of the optical beam can be stabilized without fluctuation.

An optical beam output control method according to one embodiment of the present invention includes an upper limit value comparing step of comparing an intensity signal according to the emitting intensity of an optical beam with a predetermined upper limit value, a lower limit value comparing step of comparing the intensity signal with a predetermined lower limit value smaller than the upper limit value, and an output value control step of decreasing the output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

Thus, when the intensity signal is smaller than the upper limit value and larger than the lower limit value, the output value is held by the output value control means. Accordingly, the output intensity of the optical beam can be stabilized without fluctuation.

Further, an optical beam output control program according to one embodiment of the present invention for making an optical beam output controller for controlling an output intensity of an optical beam emitted on an optical disk when data is written to the optical disk or data is read from the optical disk, execute the steps of: an upper limit value comparing step of comparing an intensity signal according to an emitting intensity of the optical beam with a predetermined upper limit value; a lower limit value comparing step of comparing the intensity signal with a predetermined lower limit value smaller than the upper limit value; and an output value control step of decreasing the output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

Thus, when the intensity signal is smaller than the upper limit value and larger than the lower limit value, the output value is held by the output value control means. Accordingly, the output intensity of the optical beam can be stabilized without fluctuation.

Further, the optical disk device according to one embodiment of the present invention for controlling an output intensity of an optical beam emitted on an optical disk when data is written to the optical disk or data is read from the optical disk includes an upper limit value comparing means for comparing the intensity signal with a predetermined upper limit value, a lower limit value comparing means for comparing the intensity signal with the predetermined lower limit value smaller than the upper limit value, an output value control means for decreasing an output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value, and an optical beam output means for regulating the output intensity based on the output value to output the optical beam.

Thus, when the intensity signal is smaller than the upper limit value and larger than the lower limit value, the output value is held by the output value control means, and the output intensity of the optical beam can be stabilized without fluctuation. Accordingly, the data can be stably recorded on the optical disk, and data can be stably reproduced from the optical disk.

According to one embodiment of the present invention, when the intensity signal is smaller than the upper limit value and larger than the lower limit value, the output value is held by the output value control means. Accordingly, the output intensity of the optical beam can be stabilized without fluctuation. Thus, the optical beam output controller which stably outputs the optical beam can be realized.

Further, according to one embodiment of the present invention, when the intensity signal is smaller than the upper limit value and larger than the lower limit value, the output value is held by the output value control means, the output intensity of the optical beam can be stabilized without fluctuation. Accordingly, the data can be stably recorded on the optical disk, and data can be stably reproduced from the optical disk. Thus, the optical disk device in which the recording and reproducing accuracy of data with respect to the optical disk is improved, can be realized.

The nature, principle and utility of the invention will become more apparent from the following detailed description when read in conjunction with the accompanying drawings in which like parts are designate by like reference numerals or characters.

### BRIEF DESCRIPTION OF THE DRAWINGS

In the accompanying drawings:

FIG. 1 is a block diagram showing a circuit configuration of an optical disk device according to one embodiment of the present invention;

FIG. 2 is a block diagram showing a circuit configuration of a laser drive controller according to one embodiment of the present invention;

FIG. 3 is a schematic circuit diagram showing the configuration of a low-pass filter with a sample holder;

FIGS. 4A to 4C are schematic views showing the relationship between a low-band signal and the output value of a comparator;

FIG. 5 is a schematic diagram showing the output value of an up-down counter;

FIG. 6 is a schematic signal waveform diagram showing an example of a light strategy; and

FIG. 7 is a flowchart showing the laser output control processing sequence.

### DETAILED DESCRIPTION OF THE PREFERRED EMBODIMENTS

An embodiment of the present invention will be described in detail with reference to the drawings.

(1) Entire Configuration of Optical Disk Device

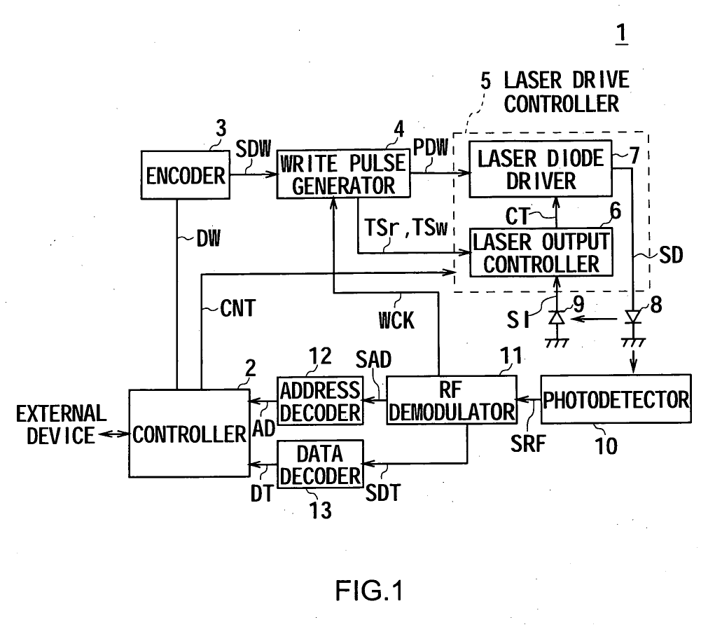

In FIG. 1, reference numeral 1 shows the entire configuration of the optical disk device. Data is adapted to be written in and readout from an optical disk (not shown) of a Blu-ray disk (Registered Trademark).

The optical disk device 1 controls the whole device by way of a controller 2. When the optical disk device 1 receives a data read command for reading the data from the optical disk from an external unit (not shown), it supplies a control signal CNT according to the data read command to a laser drive controller 5.

A write pulse generator 4 generates a timing signal TSr for reading when a write data signal SDW to be described later is not supplied, and supplies the timing signal TSr to a laser output controller 6 of the laser drive controller 5.

The laser drive controller 5 generates a counter value CT for specifying the output intensity of the laser beam by the laser output controller 6 based on the control signal CNT and the timing signal TSr and then supplies the counter value CT to a laser diode driver 7. The laser diode driver 7 generates a drive signal SD based on the counter value CT, supplies the counter value CT to a laser diode 8, and thereby emitting the laser beam of output intensity based on the drive signal SD from the laser diode 8 (to be described in detail later).

A monitor photodetector 9 is adapted to monitor the laser beam emitted from the laser diode 8. Thus, the monitor photodetector 9 generates a light receiving signal SI according to the amount of received laser beam and transmits the light receiving signal SI to the laser output controller 6. The laser output controller 6 changes the counter value CT according to the light receiving signal SI acquired from the monitor photodetector 9 and supplies the counter value CT to the laser diode driver 7.

The laser diode driver 7 generates the drive signal SD based on the new counter value CT, and supplies the drive signal SD to the laser diode 8. Thus, the laser beam regulated in the output intensity under the feedback control is emitted from the laser diode 8 (to be described in detail later).

On the other hand, a photodetector 10 receives the reflected laser beam emitted from the laser diode 8 and reflected by the optical disk (not shown), photoelectric converts the reflected laser beam, generates a reproduction RF signal SRF, and supplies the reproduction RF signal SRF to an RF demodulator 11.

The RF demodulator 11 performs a predetermined RF demodulating process on the reproduction RF signal SRF, then generates an address signal SAD and a data signal SDT, and respectively supplies the signals SAD and SDT to an address decoder 12 and a data decoder 13.

The address decoder 12 performs a predetermined decoding process on the address signal SAD to decode the address signal SAD to an address value AD, and supplies the address value AD to the controller 2. Further, the data decoder 13 performs a predetermined decoding process on the data signal SDT to decode the data signal SDT to data DT, and supplies the data DT to the controller 2.

The controller 2 generates reproduction data based on the address value AD and the data DT. The controller 2 then sends the reproduction data to an external unit (not shown). Thus, the reproduction data is made to correspond to the data read command from the external unit.

Further, the controller 2 receives a data write command and data DW to be written from the external unit. Then, the controller 2 supplies the control signal CNT according to the data write command to the laser drive controller 5 and also supplies the write data DW to the encoder 3.

The encoder 3 performs a predetermined encoding process on the write data DW to generate a write data signal SDW, and supplies the write data signal SDW to the write pulse generator 4.

The write pulse generator 4 generates a write data pulse PDW based on the write data signal SDW and then supplies the write data pulse PDW to a laser diode driver 7 of the laser drive controller 5. When a write clock signal WCK is supplied from the RF demodulator 11, the write pulse generator 4 generates, in addition to the above-mentioned timing signal TSr, a timing signal TSw for writing based on the write clock signal WCK, and supplies the timing signals TSr and TSw to the laser output controller 6 (to be described in detail later).

The laser output controller 6 generates the counter value CT based on the control signal CNT, and supplies the counter value CT to the laser diode driver 7. The laser diode driver 7 generates the drive signal SD based on the counter value CT and supplies the drive signal SD to the laser diode 8 at the timing matching to the write clock signal WCK. Thus, the laser diode 8 emits the laser beam of the output intensity based on the drive signal SD under the feedback control (to be described in detail later).

The monitor photodetector 9 generates the light receiving signal SI according to the amount of the laser beam received from the laser diode 8, similarly to the case of reading the data from the optical disk for reproduction and sends the light receiving signal SI to the laser output controller 6. The laser output controller 6 generates a new counter value CT according to the light receiving signal SI acquired from the monitor photodetector 9, and supplies the counter value CT to the laser diode driver 7. The laser diode driver 7 emits the laser beam regulated in the output intensity from the laser diode 8 in response to the counter value CT.

When the data is written in the optical disk, the RF demodulator 11 performs a predetermined RF demodulating process on the reproduction RF signal SRF to generate the write clock signal WCK, and supplies the write clock signal WCK to the write pulse generator 4.

In accordance with the supply of the write clock signal WCK to the write pulse generator 4, it generates a new data pulse PDW, and also generates new timing signals TSr and TSw.

(2) Circuit Configuration of Laser Drive Controller 5

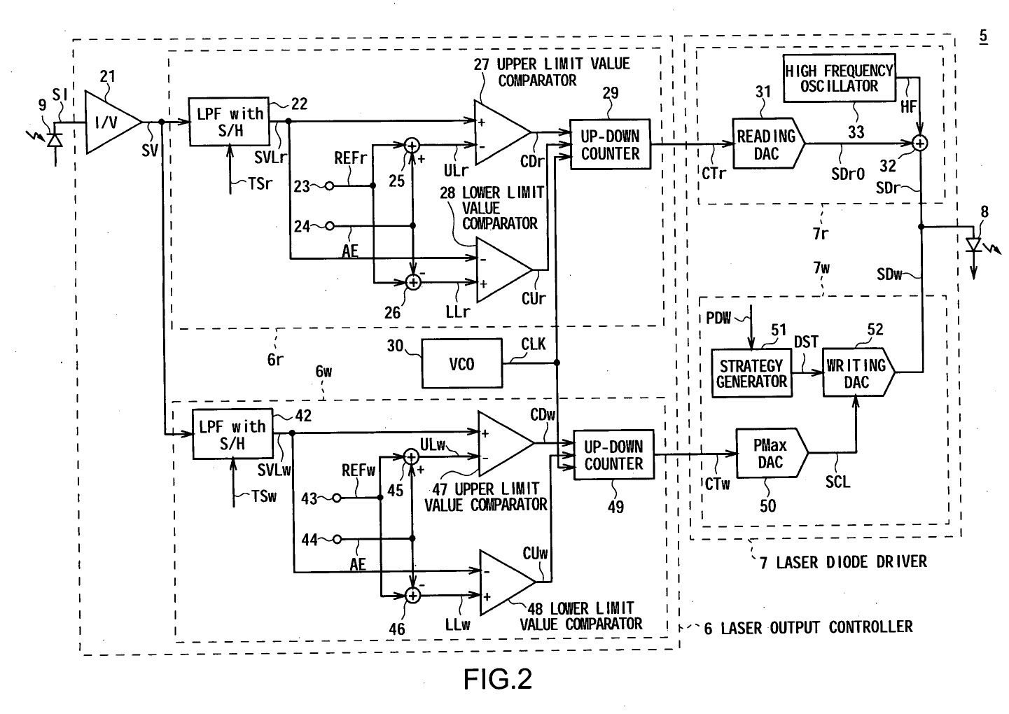

Subsequently, the circuit configuration of the laser drive controller 5 will be described. As shown in FIG. 2, this laser drive controller 5 is largely divided into the laser output controller 6 and the laser diode driver 7.

The laser output controller 6 is divided into a laser output controller 6r for reading data and a laser output controller 6w for writing data, which are made of substantially equal circuit configurations. Further, the diode driver 7 is divided into a diode driver 7r for reading data and a diode driver 7w for writing data.

When the optical disk device 1 (FIG. 1) reads the data from the optical disk (not shown), the laser diode 8 emits the laser beam based on the drive signal SD supplied from the diode driver 7 of a preceding stage. The monitor photodetector 9 receives the part of the laser beam at this time, and performs a photoelectric conversion to generate the light receiving signal SI described with the light receiving intensity in the amplitude of a current. The monitor photodetector 9 supplies the light receiving signal SI to a current/voltage converter 21 of the laser output controller 6.

The current/voltage converter 21 generates an intensity signal SV obtained by converting the current value of the light receiving signal SI into a voltage value. The current/voltage converter 21 then supplies the intensity signal SV to a low-pass filter 22 with sample hold of the laser output controller 6r and a low-pass filter 42 with sample hold of the laser output controller 6w.

Incidentally, in the optical disk device 1, the bandwidth of the intensity signal SV is set to about 100 MHz to record and reproduce at a high speed of about twice or more of a standard on the optical disk of the Blu-ray disk (Registered trademark).

However, in the laser output controller 6r, a signal bandwidth necessary for the feedback control is only a low bandwidth component of 1 MHz or less, and a signal component other than this bandwidth is not required.

Moreover, the laser diode 8 emits the laser beam modulated based on the drive signal SD. However, a noise component, such as a quantization noise, etc., is included in the laser beam. In the light receiving signal SI generated by the monitor photodetector 9, the noise component other than the laser beam actually emitted from the laser diode 8 is included. Furthermore, even in each circuit constituting the laser output controller 6, a noise is slightly superposed on each signal, such as the intensity signal SV, etc.

As described above, when the noise is included in the intensity signal SV, the intensity signal SV becomes a value far from the output intensity of the actual laser beam emitted from the laser diode 8. Accordingly, there is a possibility that following feedback processing may not be correctly performed.

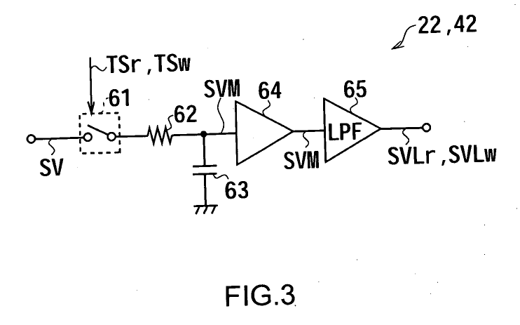

Here, the low-pass filter 22 with the sample hold has a circuit configuration as shown in FIG. 3. The low-pass filter 22 switches a switch 61 to a connecting state or a disconnecting state based on the timing signal TSr to let the intensity signal SV pass through only a predetermined period. Further, a resistor 62 and a capacitor 63 are adapted to function as a low-pass filter, thereby, generating an intermediate low bandwidth signal SVM in which only the low bandwidth component of the intensity signal SV is extracted to temporarily stores (sample holds) the intermediate low bandwidth signal SVM in a buffer 64. Further, a low-pass filter 65 extracts only the low band width component of a predetermined cut-off frequency (1 MHz) or less of the intermediate low bandwidth signal SVM to generate a low bandwidth signal SVLr and then sends the low bandwidth signal SVLr to a next stage.

That is, the low-pass filter 22 with the sample hold sample holds the intensity signal SV inputted from the preceding stage based on the timing signal TSr, and extracts only the low bandwidth component to generate the low bandwidth signal SVLr.

Incidentally, the low-pass filter 22 with the sample hold is adapted to extract the low bandwidth component at two stages of the low-pass filter having the resistor 62 and the capacitor 63 and the low-pass filter 65. Thus, the low-pass filter 22 is adapted to extract the low bandwidth component steadily.

As a result, the low-pass filter 22 with the sample hold removes all the signal component and the noise component of 1 MHz or more from the intensity signal SV having the bandwidth of about 100 MHz. Accordingly, at the same time, the low-pass filter 22 can remarkably reduce the power of the noise component in, the low bandwidth signal SVLr from the intensity signal SV.

The low-pass filter 22 with the sample hold in the laser output controller 6r (FIG. 2) supplies the low bandwidth signal SVLr generated in this manner to the upper limit value comparator 27 and the lower limit value comparator 28.

To a reference value supply terminal 23, a reference value REFr corresponding to the intensity of the laser beam to be emitted from the laser diode 8 when the optical disk device 1 reads the data from the optical disk is supplied from the controller 2 (FIG. 2) as an analog value. Thus, the reference value REFr is supplied to adders 25 and 26.

To a tolerance supply terminal 24 (FIG. 2), an allowable difference AE displaying an allowable error in the intensity of the laser beam to be emitted from the laser diode 8 when the optical disk device 1 reads the data from the optical disk is supplied as an analog value from the controller 2 (FIG. 1). The allowable difference AE is supplied to the adders 25 and 26.

Incidentally, the allowable difference AE is set to a value slightly smaller than the actual allowable error in the intensity of the laser beam to be emitted from the laser diode 8.

The adder 25 adds the allowable difference AE to the reference value REFr according to the following formula:
ULr=REFr+AE (1)
Thus, the adder 25 generates the upper limit value ULr in the intensity of the laser beam, and supplies the upper limit value ULr to the upper limit value comparator 27.

The adder 26 subtracts the allowable difference AE from the reference value REFr according to the following formula:
LLr=REFr−AE (2)
Thus, the adder 26 generates the lower limit value LLr in the intensity of the laser beam, and supplies the lower limit value to the lower limit value comparator 28.

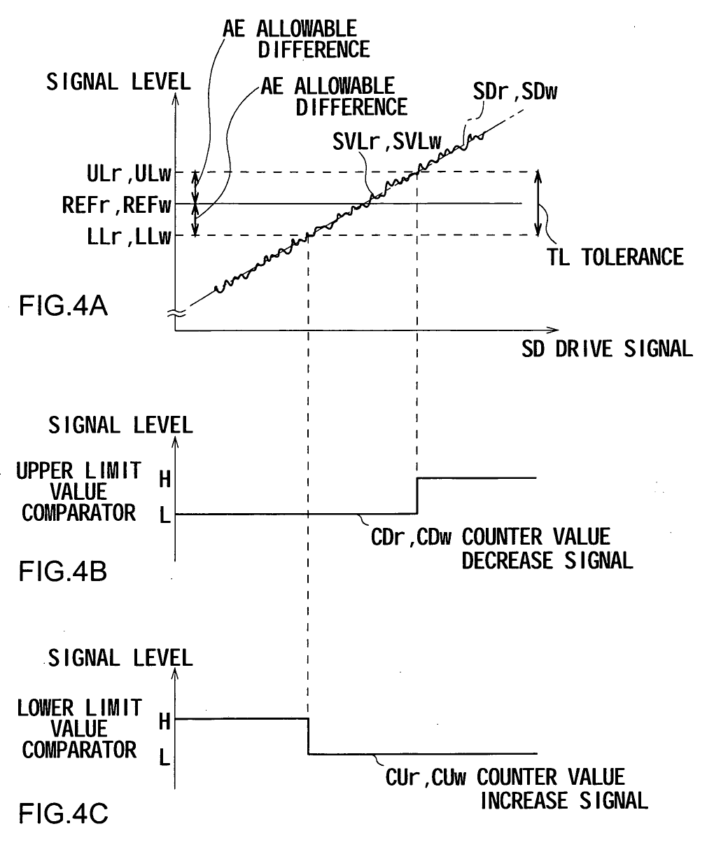

Here, the relationships between the reference value, the upper limit value Ulr and the lower limit value LLr, and the low bandwidth signal SVLr are shown in FIG. 4A. In FIGS. 4A to 4C, a tolerance TL is twice as large as the allowable difference AE, and indicates a range between the upper limit value ULr and the lower limit value LLr as the reference value REFr center. That is, if the low bandwidth signal SVLr falls within a range of this tolerance TL, this means that the intensity of the laser beam to be emitted from the laser diode 8 (FIG. 2) certainly falls within the range of the tolerance and the data can be read stably and accurately from the optical disk (not shown).

In fact, as shown in FIG. 4A, the low bandwidth signal SVLr changes according to the drive signal SD (shown by a dotted chain line in the drawings), but has a minute change according to the influence of various noises, etc.

Incidentally, from the low bandwidth signal SVLr, most of the noise components included in the intensity signal SV are removed by the low-pass filter 22 with the sample hold (FIG. 2). Accordingly, the amplitude of the above-mentioned minute change becomes sufficiently small as compared with the amplitude of the allowable difference AE.

The upper limit value comparator 27 (FIG. 2) compares the low bandwidth signal SVLr supplied from the low-pass filter 22 with the sample hold with the upper limit value ULr supplied from the adder 25. As shown in FIG. 4B, if the low bandwidth signal SVLr is larger than the upper limit value ULr, “H” is supplied as a counter value decrease signal CDr to the up-down counter 29. If the low bandwidth signal SVLr is equal to the upper limit vale ULr or less, “L” is supplied as the counter value decrease signal CDr to the up-down counter 29.

The lower limit value comparator 28 (FIG. 2) compares the low bandwidth signal SVLr supplied from the low-pass filter 22 with the sample hold with the lower limit value LLr supplied from the adder 26. As shown in FIG. 4C, if the low bandwidth signal SVLr is smaller than the lower limit value LLr, “H” is supplied as a counter value increase signal CUr to the up-down counter 29. If the low bandwidth signal SVLr is the lower limit vale LLr or more, “L” is supplied as the counter value increase signal CUr to the up-down counter 29.

The up-down counter 29 is adapted to generate and output the read counter value CTr according to the counter value decrease signal CDr and the counter value increase signal CUr as shown in FIG. 5.

That is, if the counter value decrease signal CDr supplied to the up-down counter 29 is “H” and the counter value increase signal CUr is “L”, this indicates that in FIG. 4A, the low bandwidth signal SVLr at this time is deviated from the range of the tolerance TL and is larger than the upper limit value ULr, that is, the signal level of the drive signal SDr is excessively large.

At this time, the up-down counter 29 decreases the signal level of the drive signal SDr in FIG. 4A to thereby decreases the signal level of the low bandwidth signal SVL, and generates the counter value CTr which is reduced by “1” from the counter value CTr immediately before to match the timing of the clock signal CLK supplied from a Voltage Controlled oscillator (VCO) 30 to fall within the range of the tolerance TL. Then, the up-down counter 29 supplies the counter value CTr to a Digital Analog Converter (DAC) for reading 31 of the laser diode driver 7r.

Moreover, when the counter value decrease signal CDr supplied to the up-down counter 29 is “L” and the counter value increase signal CUr is “H”, this indicates that the low bandwidth signal SVLr shown in FIG. 4A at this time is deviated from the range of the tolerance TL and is smaller than the lower limit value LLr, that is, the signal level of the drive signal SDr is excessively low.

At this time, the up-down counter 29 increases the signal level of the drive signal SDr in FIG. 4A to thereby increasing the signal level of the low bandwidth signal SVLr. The up-down counter 29 generates the counter value CTr which is increased by “1” as compared with the counter value CTr immediately before to match the timing of the clock signal CLK to fall in the range of the tolerance TL. Thus, the up-down counter 29 supplies the counter value CTr to the reading DAC 31.

Furthermore, if the counter value decrease signal CDr supplied to the up-down counter 29 is “L” and the counter value increase signal CUr is “L”, this indicates that in FIG. 4A, the low bandwidth signal SVLr at this time is included in the range of the tolerance TL.

At this time, the up-down counter 29 does not change the signal level of the drive signal SDr in FIG. 4A. Thus, the up-down counter 29 supplies the counter value CTr held at the counter value CTr immediately before to the reading DAC 31 to match the timing of the clock signal CLK to maintain the state falling in the range of the tolerance TL without changing the signal level of the low bandwidth signal SVLr.

Incidentally, in the up-down counter 29, case that the counter value decrease signal CDr is “H” and the counter value increase signal Cur is “H” do not principally exist. However, by considering possibility that such a value is temporarily inputted by the influence of a noise, various errors, etc., the counter value CTr being held at the counter value CTr immediately before, is supplied to the reading DAC 31. Thus, the up-down counter 29 prevents functional errors in advance.

The reading DAC 31 performs a digital/analog conversion on the counter value CTr supplied from the up-down counter 29. Thus, the reading DAC 31 generates a drive signal SDr0, and supplies the drive signal SDr0 to the adder 32.

Incidentally, the reading DAC 31 is set such that one step of the drive signal SDr corresponding to “1” of the counter value CTr is sufficiently reduced to about ⅛ or less of the allowable difference AE (FIGS. 4A to 4C). Thus, when the counter value CTr is changed by “1”, the low bandwidth signal SVLr does not exceed the range of the tolerance TL.

The adder 32 superposes a high frequency signal HF supplied from a high frequency oscillator 33 on the drive signal SDr0. Thus, the adder 32 generates a drive signal SDr, and supplies the drive signal SDr to the laser diode 8. The laser diode 8 is adapted to emit the laser beam of output intensity based on the drive signal SDr.

The laser drive controller 5 repeats a series of operations of receiving the laser beam again, generating the counter value CTr based on the low bandwidth signal SVLr, and supplying the drive signal SDr to the laser diode 8.

As described above, when the optical disk device 1 (FIG. 1) reads data from the optical disk (not shown), the laser drive controller 5 feedback controls the drive signal SDr. Thus, the low bandwidth signal SVLr corresponding to the output intensity of the laser beam emitted from the laser diode 8 falls within the range of the tolerance TL (FIGS. 4A to 4C).

Further, when the optical disk device 1 (FIG. 1) writes data on the optical disk (not shown), the laser diode 8 emits the laser beam based on the drive signal SDw supplied from the diode driver 7w of the preceding stage. The monitor photodetector 9 generates the light receiving signal SI, and supplies the light receiving signal SI to the current/voltage converter 21 of the laser output controller 6. The current/voltage converter 21 generates the intensity signal SV in which the current value of the light receiving signal SI is converted into the voltage value, and supplies the intensity signal SV to the low-pass filters 22 and 42 with the sample holds.

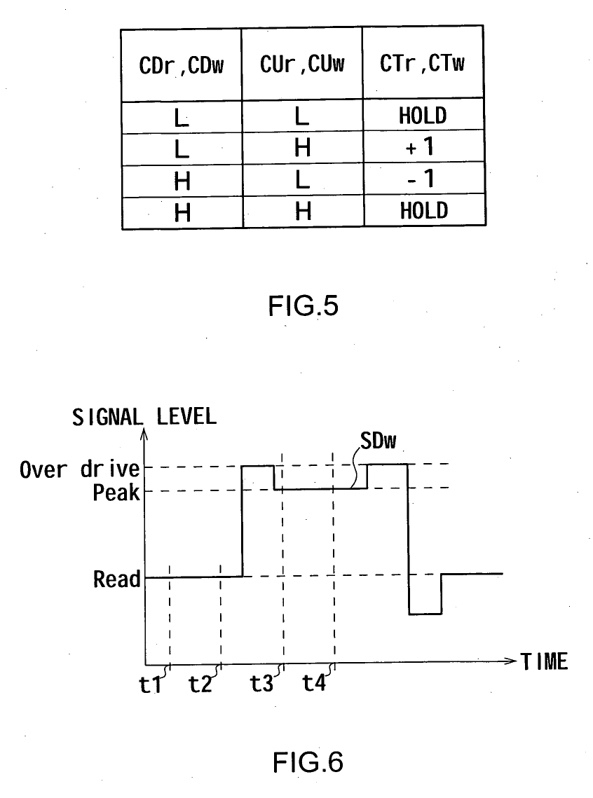

Incidentally, the optical disk device 1 supplies the drive signal SDw based on so-called light strategy as shown in FIG. 6 to the laser diode 8. Accordingly, the current/voltage converter 21 generates the intensity signal SV made of a waveform according to the light strategy.

The laser output controller 6w has the configuration similar to that of the above-mentioned laser output controller 6r. The low-pass filter 42 with sample hold has a circuit configuration shown in FIG. 3, similarly to the low-pass filter 22 with the sample hold. However, to the switch 61, a timing signal TSw and a timing signal TSr synchronized with the drive signal SDw supplied to the laser diode 8, are supplied from the write pulse generator 4 (FIG. 1).

The low-pass filter 42 with the sample hold performs sample hold by making the switch 61 (FIG. 3) in a connecting state only between time t3 and time t4, that is, at the time of peak power in the light strategy shown in FIG. 6, based on the timing signal TSw. Further, the low-pass filter 42 generates a low bandwidth signal SVLw in which only the low bandwidth component is extracted by the resistor 62, the capacitor 63 and the low-pass filter 65, and supplies the low bandwidth signal SVLw to the upper limit value comparator 47 and the lower limit value comparator 48.

As described above, the low-pass filter 42 with the sample hold can generate a low bandwidth signal SVLw in which the signal level is stabilized, based on an intensity signal SV corresponding at the time of peak power where the signal level becomes substantially constant from the intensity signals SV in which the signal level is variously changed based on the light strategy.

On the other hand, the low-pass filter 22 with the sample hold performs sample hold by making the switch 61 (FIG. 3) in a connecting state only between time t1 and time t2, that is, at the time of lead power in the light strategy shown in FIG. 6 based on the timing signal TSr at this writing time, and sample holds. Further, the low-pass filter 22 with the sample hold of the laser output controller 6w generates a low bandwidth signal SVLr in which only the low bandwidth component is extracted by the resistor 62, the capacitor 63 and the low-pass filter 65, and supplies the low band width signal SVLr to the upper limit value comparator 27 and the lower limit value comparator 28.

As described above, the low-pass filter 22 with the sample hold can generate a low bandwidth signal SVLr in which the signal level is stabilized, based on the intensity signal SV corresponding at the time of lead power where the signal level becomes substantially constant from the intensity signals SV in which the signal level is variously changed based on the light strategy.

To the reference value supply terminal 43, a reference value REFw corresponding to the intensity of the laser beam to be emitted from the laser diode 8 when the optical disk device 1 (FIG. 1) writes data on the optical disk by the controller 2 (FIG. 1), is supplied as an analog value, and the reference value REFw is supplied to the adders 45 and 46.

To the allowable difference value supply terminal 44 (FIG. 2), similarly to the allowable difference value supply terminal 24, the allowable difference AE is supplied as an analog value, and the allowable difference AE is supplied to the adders 45 and 46.

The adder 45 adds, similarly to the adder 25, the allowable difference AE to the reference value REFw according to the following formula:
ULw=REFw+AE (3)
Thus, the adder 45 generates the upper limit value ULw, and supplies the upper limit value ULw to the upper limit value comparator 47.

The adder 46 subtracts, similarly to the adder 26, the allowable difference AE from the reference value REFw according to the following formula:
LLw=REFw−AE (4)
Thus, the adder 46 generates the lower limit value LLw, and supplies the lower limit value LLw to the lower limit value comparator 48.

The upper limit value comparator 47 compares, similarly to the upper limit value comparator 27, the low bandwidth signal SVLw with the upper limit value ULw. As shown in FIG. 4B, if the low bandwidth signal SVLw is larger than the upper limit value ULw, “H” is supplied as the counter value decrease signal CDw to the up-down counter 49. If the low bandwidth signal SVLw is equal to the upper limit value ULw or less, “L” is supplied as the counter value decrease signal CDw to the up-down counter 49.

The lower limit comparator 48 compares, similarly to the lower limit value comparator 28, the low bandwidth signal SVLw with the lower limit value LLw. As shown in FIG. 4C, if the low bandwidth signal SVLw is smaller than the lower limit value LLW, “H” is supplied as the counter value increase signal CUw to the up-down counter 49. If the low bandwidth signal SVLw is not less than the lower limit value LLw, “L” is supplied as the counter value increase signal CUw to the up-down counter 49.

As shown in FIG. 5, the up-down counter 49 increases, decreases or holds, similarly to the up-down counter 29, the read counter value CTw according to the counter value decrease signal CDw and the counter value increase signal CUw, and supplies the read counter value CTw to the PmaxDAC 50 of the laser diode driver 7w.

The PmaxDAC 50 performs a digital/analog conversion on the counter value CTw supplied from the up-down counter 49. Thus, the PmaxDAC 50 generates a scale signal SCL for specifying the maximum amplitude of the drive signal SDw outputted from the writing DAC 52, and supplies the scale signal SCL to the writing DAC 52.

The strategy generator 51 generates strategy data DST according to the write pulse signal PDW supplied from the write pulse generator 4 (FIG. 1), and supplies the strategy data DST to the writing DAC 52.

Incidentally, the strategy generator 51 is adapted to generate the strategy data DST according to the type of the optical disk of rewritable type or write-once type based on the control signal CNT.

The writing DAC 52 generates the drive signal SDw made of an analog signal of a scale according to the scale signal SCL based on the strategy data DST supplied from the strategy generator 51, and supplies the drive signal SDw to the laser diode 8. The laser diode 8 is adapted to emit the laser beam according to the drive signal SDw in response to the supply of the drive signal SDw.

The laser drive controller 5 repeats a series of operations of receiving again the laser beam, generating the counter value CTw based on the low bandwidth signal SVLw, and supplying the drive signal SDw to the laser diode 8.

As described above, the laser drive controller 5 feedback controls the drive signal SDw, similarly to the case that the optical disk device 1 (FIG. 1) writes data on the optical disk (not shown) and the case that the data is read from the optical disk. Thereby, the laser drive controller 5 makes the low bandwidth signal SVLw corresponding to the output intensity of the laser beam emitted from the laser diode 8 fall within the range of the tolerance TL (FIGS. 4A to 4C).

(3) Laser Output Control Processing Sequence

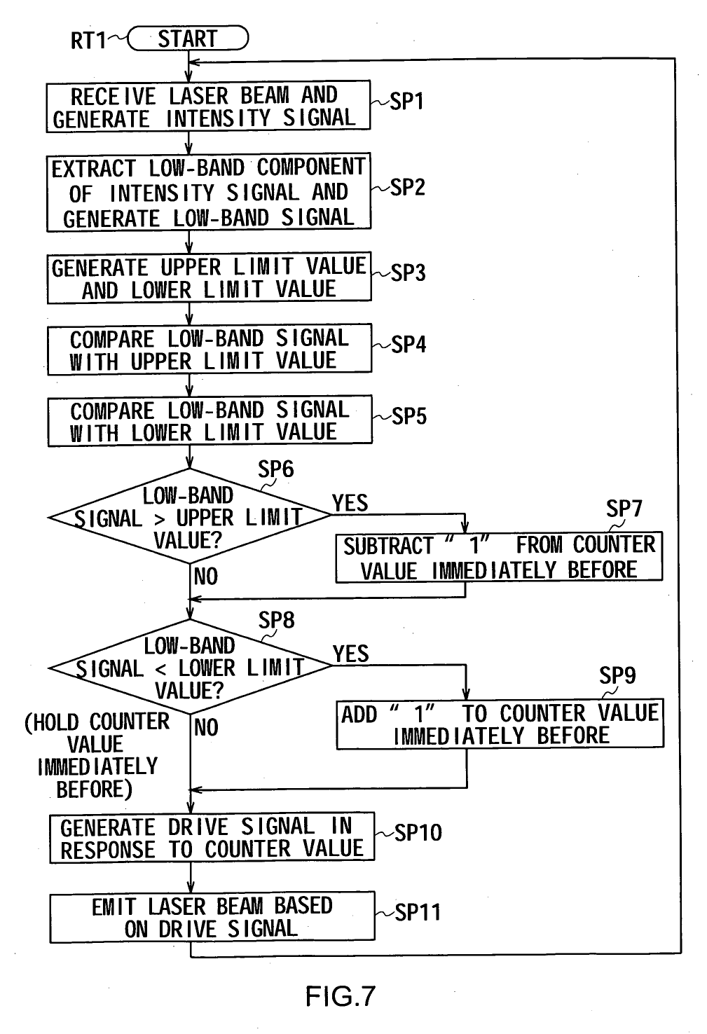

Here, the laser output control processing sequence for controlling the output intensity of the laser beam emitted from the laser diode 8 in the laser drive controller 5 will be described by using a flowchart shown in FIG. 7.

When the laser drive controller 5 receives the control signal CNT (FIG. 1) according to the data read instruction from an external device, from the controller 2 of the optical disk device 1, the laser drive controller 5 starts the laser output control processing sequence RT1, and transfers to step SP1.

In step SP1, the laser drive controller 5 receives the part of the laser beam emitted immediately before from the laser diode 8 by the monitor photodetector 9, and generates the intensity signal SV by the current/voltage converter 21. Then, the laser drive controller 5 supplies the intensity signal SV to the low-pass filter 22 with the sample hold of the laser output controller 6r, and transfers to next step SP2.

In step SP2, the laser drive controller 5 extracts the low bandwidth component of the intensity signal SV by the low-pass filter 22 with the sample hold, and generates the low bandwidth signal SLVr. Then, the laser drive controller 5 supplies the low bandwidth signal SLVr to the upper limit value comparator 27 and the lower limit value comparator 28, and transfers to next step SP3.

In step SP3, the laser drive controller 5 adds the allowable difference AE to the reference value REFr by the adder 25, generates the upper limit value ULr and then supplies the upper limit value ULr to the upper limit value comparator 27. The laser drive controller 5 of the optical disk device 1 generates the lower limit value LLr by subtracting the allowable difference AE from the reference value REFr by the adder 26, and supplies the lower limit value LLr to the lower limit value comparator 28, and then transfers to next step SP4.

In step SP4, the laser drive controller 5 compares the low bandwidth signal SVLr with the upper limit value ULr by the upper limit value comparator 27, and generates a counter value decrease signal CDr as shown in FIG. 4B according to the comparison result. Then, the laser drive controller 5 supplies the counter value decrease signal CDr to the up-down counter 29 in the laser output controller 6r, and transfers to next step SP5.

In step SP5, the laser drive controller 5 compares the low bandwidth signal SVLr with the lower limit value LLr by the lower limit value comparator 28, and generates the counter value increase signal CUr as shown in FIG. 4C according to the comparison result. The laser drive controller 5 supplies the counter value increase signal Cur to the up-down counter 29, and transfers to next step SP6.

In step SP6, the laser drive controller 5 judges whether the counter value decrease signal CDr is “H” or not, by the up-down counter 29, that is, whether the low bandwidth signal SVLr is larger than the upper limit value ULr. Here, a positive result indicates that the low bandwidth signal SVLr is larger than the upper limit value ULr and the output intensity of the laser beam emitted from the laser diode 8 immediately before is excessively large. At this time, the laser drive controller 5 transfers to next step SP7.

In step SP7, the laser drive controller 5 generates the counter value CTr in which “1” is subtracted from the counter value CTr immediately before by the up-down counter 29, and transfers to next step SP8.

On the other hand, in step SP6, when a negative result is obtained, the laser drive controller 5 does not change the counter value CTr, and transfer to next step SP8.

In step SP8, the laser drive controller 5 judges whether the counter value increase signal CUr is “H” or not, by the up-down counter 29, that is, whether the low bandwidth signal SVLr is smaller than the lower limit value LLr. Here, a positive result indicates that the low bandwidth signal SVLr is smaller than the lower limit value LLr and the output intensity of the laser beam emitted from the laser diode 8 immediately before is excessively small. At this time, the laser drive controller 5 transfers to next step SP9.

In step SP9, the laser drive controller 5 generates the counter value CTr in which “1” is added to the counter value CTr immediately before by the up-down counter 29, and transfers to next step SP10.

On the other hand, when the negative result is obtained in step SP8, this indicates that the counter value increase signal CUr is “L”. At this time, the laser drive controller 5 does not change the counter value CTr, and transfers to next step SP10.

Here, when the counter value decrease signal CDr and the counter value increase signal CUr are “L”, this indicates that the low bandwidth signal SVLr is between the upper limit value ULr and the lower limit value LLr and the output intensity of the laser beam emitted from the laser diode 8 immediately before falls within the range of the tolerance TL. It means that the counter value CTr need not be changed.

Further, when the counter value decrease signal CDr and the counter value increase signal CUr are “H”, the possibility of the occurrence of an error or the like is high. Accordingly, it is preferable not to change the counter value CTr positively. For this reason, the laser drive controller 5 subtracts “1” from the counter value CTr immediately before in step SP7 and adds “1” to the counter value CTr immediately before in step SP9. Thereby, the laser drive controller 5 transfers to next step SP10 while holding and without changing the counter value CTr accordingly.

In step SP10, the laser drive controller 5 supplies the counter value CTr to the reading DAC 31 of the laser diode driver 7r, and generates the drive signal SDr by the reading DAC 31 and the high frequency oscillator 32, etc. Then, the laser driver controller 5 supplies the drive signal SDr to the laser diode 8, and transfers to next step SP12.

In step SP11, the laser drive controller 5 emits the laser beam from the laser diode 8 based on the drive signal SDr, and returns again to step SP1.

Incidentally, even when the laser drive controller 5 receives the control signal CNT according to the data write command from the external unit from the controller 2 of the optical disk device 1, the laser drive controller 5 is adapted to control the output intensity of the laser beam similarly according to the laser output control processing sequence RT1.

(4) Operation and Effect

In the above-mentioned configuration, when the laser drive controller 5 of the optical disk device 1 reads data from the optical disk (not shown), the laser drive controller 5 extracts only the low bandwidth component by the low-pass filter 22 with the sample hold based on the intensity signal SV when receiving the laser beam emitted from the laser diode 8, and generates the low bandwidth signal SVLr. The laser drive controller 5 compares the low bandwidth signal SVLr with the upper limit value ULr and the lower limit value LLr by the upper limit value comparator 27 and the lower limit value comparator 28, respectively. The laser drive controller 5 then generates the counter value decrease signal CDr and the counter value increase signal CUr as comparison results (FIG. 4).

Further, the laser drive controller 5 decreases “1” from the counter value CTr immediately before by the up-down counter 29 if the counter value decrease signal CDr is “H”, and increases “1” to the counter value CTr immediately before if the counter value increase signal CUr is “H”. When the counter value decrease signal CDr and the counter value increase signal CUr are “L”, the laser drive controller 5 outputs the counter value CTr while holding and without changing the counter value CTr immediately before. The laser drive controller 5 then generates the drive signal SDr according to the output of the counter value CTr, and emits the laser beam from the laser diode 8.

Therefore, when the counter value decrease signal CDr and the counter value increase signal CUr are “L”, the laser drive controller 5 considers the state appropriate that the low bandwidth signal SVLr corresponding to the output intensity of the laser beam immediately before is included in the range of the tolerance TL (FIG. 4A). Then, the laser drive controller 5 can output the counter value CTr from the up-down counter 29 while holding and without changing the counter value CTr immediately before (FIG. 5) to maintain this state.

Particularly in this case, the laser drive controller 5 compares the low bandwidth signal SVLr with both the upper limit value ULr and the lower limit value LLr by two comparators such as the upper limit value comparator 27 and the lower limit value comparator 28. The laser drive controller 5 judges whether the low bandwidth signal SVLr falls within the range of the tolerance TL. Accordingly, the laser drive controller 5 can prevent the drive signal SDr from being fluctuated with respect to the reference value REF by alternately repeating the increase and the decrease of the drive signal SDr in case if only one comparator is used to compare the low bandwidth signal SVLr with the reference value REF.

Accordingly, the laser drive controller 5 can generate the drive signal SDr of the same level immediately before by supplying the counter value CTr holding the value immediately before to the reading DAC 31. Therefore, the laser drive controller 5 can hold the state that the signal level of the low bandwidth signal SVLr falls within the range of the tolerance TL and the laser beam of the stable output intensity without fluctuation from the laser diode 8.

As a result, the optical disk device 1 can emit the optical disk with the laser beam having stable output intensity. Accordingly, data can stably be read with high accuracy from the optical disk.

Further, the laser drive controller 5 extracts only the low bandwidth component of the intensity signal SV by the low-pass filter 22 with the sample hold. Thereby, the laser drive controller 5 can remove all the noise component together with the signal component included other than the low bandwidth. Accordingly, the laser drive controller 5 can relatively reduce the power of the noise component in the low bandwidth signal SVLr.

Particularly, the laser drive controller 5 can remarkably suppress the signal level of the noise component as compared with the tolerance TL (FIGS. 4A to 4C). Accordingly, the laser drive controller 5 can correctly compare the upper limit value ULr and the lower limit value LLr with the low bandwidth signal SVLr in the upper value comparator 27 and the lower value comparator 28. Then, the laser drive controller 5 can correctly judge whether the low bandwidth signal SVLr falls within the range of the tolerance TL in the up-down counter 29.

Further, even when data is written in the optical disk, the laser drive controller 5 can control the output intensity of the laser beam by the laser output controller 6w and the laser diode driver 7w, similarly to the case that the data is read from the optical disk.

In addition, when the data is written in the optical disk, the laser drive controller 5 sample holds only the intensity signal SV corresponding to the portion becoming the peak power of the light strategy (FIG. 6) of the drive signal SDw based on the timing signal TSw by using the sample hold function of the low-pass filter 22 with the sample hold. Thereby, the laser drive controller 5 can generate the low bandwidth signal SVLw only from the intensity signal SV in the timing of the peak power without being affected by the influence of the intensity signal SV in the timing of the other overdrive power or the lead power.

According to the above-mentioned configuration, the laser drive controller 5 extracts only the low bandwidth component of the intensity signal SV when the laser drive controller 5 receives the laser beam, and generates the low bandwidth signal SVL. The laser drive controller 5 compares the low bandwidth signal SVL with the upper limit value UL and the lower limit value LL and when the low bandwidth signal SVL falls within the range of the tolerance TL, the laser drive controller 5 outputs the counter value CT while holding and without changing the counter value CT of immediately before. The laser drive controller 5 generates the drive signal SD according to the output of the counter value CT, and emits the laser beam from the laser diode 8. Thereby, the laser drive controller 5 holds the state that the low bandwidth signal SVL falls within the range of the tolerance TL, and can stabilize the drive signal SD without fluctuation. Thereby, the optical disk device 1 can improve the recording and reproducing accuracies of the data.

(5) Other Embodiments

Incidentally, in the above-mentioned embodiments, described in the case that the analog low bandwidth signal SVLr is compared with the analog upper limit value ULr and lower limit value LLr in the upper limit value comparator 27 and the lower limit value comparator 28. However, the present invention is not limited to the particular embodiments. For example, a digitized low bandwidth signal SVLr may be compared with digital upper limit value ULr and lower limit value LLr by using the upper limit value comparator and the lower limit value comparator which can compare digital values.

Furthermore, in this case, an analog/digital converter is connected before the low-pass filter 22 with the sample hold and the low-pass filter 22 with the sample hold may process the digital signal.

Moreover, in this case, for example, the low-pass filter 22 with the sample hold, the upper limit value comparator 27, the lower limit value comparator 28 and the up-down counter 29 of the laser output controller 6r are replaced with one Digital Signal Processor (DSP). Then, the DSP may perform all the processes from step SP2 to step SP10 shown in FIG. 7 according to a laser output control program.

This laser output control program may be stored beforehand in a Read Only Memory (ROM), etc., provided in the optical disk device 1. Alternatively, the laser output control program may be installed in a nonvolatile memory of the optical disk device 1 from an external unit.

Further, in the above-mentioned embodiments, described is the case that, in the laser diode driver 7w for writing data, the scale value SCL of the writing DAC 52 is changed by the counter value CTw outputted from the up-down counter 49. However, the present invention is not limited to the particular embodiments. For example, the drive signal SDw outputted from the writing DAC 52 may be directly changed based on the counter value CTw.

Furthermore, in the above-mentioned embodiments, described is the case that the upper limit values ULr and ULw, and the lower limit values LLr and LLw are generated by adding and subtracting the reference values REFr and REFw supplied from the controller 2 (FIG. 1) and the allowable difference AE. However, the present invention is not limited to the particular embodiment. For example, the upper limit values ULr and ULw, and the lower limit values LLr and LLw may be directly supplied from the controller 2.

Further, in the above-mentioned embodiments, described is the case that only the low bandwidth components are extracted by the low-pass filters 22 and 42 with the sample holds, and simultaneously the power of the noise components is reduced. However, the present invention is not limited to the particular embodiments. For example, when the noise components are low, a simple sample hold circuit may be used instead of the low-pass filters 22 and 42 with the sample holds.

In addition, in the above-mentioned embodiments, described is the case that the optical disk device 1 can perform both the writing and reading data with respect to the optical disk. However, the present invention is not limited to the particular embodiments. For example, the present invention may be applied to the optical disk device which can, for example, either write in or read from data with respect to the optical disk. In this case, the laser drive controller 5 may have either one of the laser output controller 6w and the laser output controller 6r, and corresponding either one of the laser diode driver 7w and the laser diode driver 7r.

Further, in the above-mentioned embodiments, described is the case that the present invention is applied to the optical disk device 1 which can record data in or reproduce data from the optical disk made of the Blu-ray disk (Registered Trademark). However, the present invention is not limited to the particular embodiments. For example, the present invention may be applied to the various optical disk devices which can record data in or reproduce data from various optical disks, such as a Compact Disk (CD), a Digital Versatile Disk (DVD), etc.

Moreover, in the above-mentioned embodiments, described is the case of constituting the laser output controller 6r as the optical beam output controller of the upper limit value comparator 27 as an upper limit value comparing means for comparing the low bandwidth signal SVLr as the intensity signal with the upper limit value ULr, the lower limit value comparator 28 as a lower limit value comparing means for comparing the low bandwidth signal SVLr with the lower limit value LLr, and the up-down counter 29 as an output value control means for outputting the counter value CTr as the output value. However, the present invention is not limited to the particular embodiments. For example, the optical beam output controller may be constituted with the upper limit value comparing means, the lower limit value comparing means, and the output value control means having other various circuit configurations.

Further, in the above-mentioned embodiments, described is the case of constituting the optical disk device 1 with the monitor photodiode 9 and the current/voltage converter 21 as a photodetecting means, the upper limit value comparator 27 as an upper limit value comparing means, the lower limit value comparator 28 as a lower limit value comparing means, the up-down counter 29 as an output value control means, and the laser diode driver 7 and the laser diode 8 as optical data output means. However, the present invention is not limited to the particular embodiments. For example, the optical disk device may be constituted with the light receiving means, the upper limit value comparing means, the lower limit value comparing means, the output value control means and the optical beam output means having other various circuit configurations.

The present invention can utilize various optical disk devices which control the output intensity of the laser beam emitted from the laser diode.

It should be understood by those skilled in the art that various modifications, combinations, sub-combinations and alterations may occur depending on design requirements and other factors insofar as they are within the scope of the appended claims or the equivalents thereof.

What is claimed is:

1. An optical beam output controller for controlling an output intensity of an optical beam emitted on an optical disk when data is written on the optical disk or data is read from the optical disk, comprising:
upper limit value comparing means for comparing an intensity signal according to an emitting intensity of the optical beam with a predetermined upper limit value;
lower limit value comparing means for comparing the intensity signal with a predetermined lower limit value smaller than the upper limit value; and
output value control means for decreasing an output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

2. The optical beam output controller according to claim 1, wherein
difference between the upper limit value and the lower limit value is smaller than an allowable error to the emitting intensity of the optical beam required for the optical beam output controller and larger than a noise component included in the intensity signal.

3. The optical beam output controller according to claim 1, wherein
the output value control means regulates the output intensity of the optical beam by regulating the output value at a minimum regulating unit smaller than the amount of light corresponding to the difference between the upper limit value and the lower limit value.

4. The optical beam output controller according to claim 1, wherein
the upper limit value is made by adding a predetermined tolerance to a predetermined reference value and the lower limit value is made by subtracting the tolerance from the reference value.

5. An optical beam output control method for controlling the output intensity of an optical beam emitting an optical disk when data is written to the optical disk or data is read from the optical disk, comprising:
an upper limit value comparing step of comparing an intensity signal according to the emitting intensity of the optical beam with a predetermined upper limit value;
a lower limit value comparing step of comparing the intensity signal with a predetermined lower limit value smaller than the upper limit value; and
an output value control step of decreasing the output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

6. An optical beam output control program for making an optical beam output controller for controlling an output intensity of an optical beam emitted on an optical disk when data is written to the optical disk or data is read from the optical disk, execute the steps of:
an upper limit value comparing step of comparing an intensity signal according to an emitting intensity of the optical beam with a predetermined upper limit value;
a lower limit value comparing step of comparing the intensity signal with a predetermined lower limit value smaller than the upper limit value; and
an output value control step of decreasing the output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value.

7. An optical disk device for controlling an output intensity of an optical beam emitted on an the optical disk when data is written to the optical disk or data is read from the optical disk, comprising:
light receiving means for receiving an optical beam and generating an intensity signal according to an intensity of the optical beam;
upper limit value comparing means for comparing the intensity signal with a predetermined upper limit value;
lower limit vale comparing means for comparing the intensity signal with the predetermined lower limit value smaller than the upper limit value;
output value control means for decreasing an output value for controlling the output intensity of the optical beam from the output value immediately before when the intensity signal is larger than the upper limit value, increasing the output value from the output value immediately before when the intensity signal is smaller than the lower limit value, and holding the output value as the output value immediately before when the intensity signal is smaller than the upper limit value and larger than the lower limit value; and
optical beam output means for regulating the output intensity based on the output value to output the optical beam.

8. The optical disk device according to claim 7, wherein
the difference between the upper limit value and the lower limit value is smaller than an allowable error to the emitting intensity of the optical beam required for the optical beam output controller and larger than the noise component included in the intensity signal.

9. The optical disk device according to claim 7, wherein
the output value control means regulates the output intensity of the optical beam by regulating the output value at the minimum regulating unit smaller than the amount of light corresponding to the difference between the upper limit value and the lower limit value.

10. The optical disk device according to claim 7, wherein
the upper limit value is made by adding a predetermined tolerance to a predetermined reference value and the lower limit value is made by subtracting the tolerance from the reference value.

11. The optical disk device according to claim 7, wherein
the light receiving means generates the intensity signal by extracting only the low bandwidth component of the light receiving signal generated by receiving the optical beam.

12. The optical disk device according to claim 7, wherein
the light receiving means generates the intensity signal by taking out only the light receiving signal of the portion corresponding to the predetermined portion of the intensity pattern from the light receiving signal generated by receiving the optical beam made of a predetermined intensity pattern.

13. The optical disk device according to claim 7, wherein
the optical beam output means regulates the output intensity at the minimum regulating unit smaller than the amount of light corresponding to the tolerance.

14. An optical beam output controller for controlling an output intensity of an optical beam emitted on an optical disk when data is written to the optical disk or data is read from the optical disk, comprising:
an upper limit value comparing unit that compares an intensity signal according to an emitting intensity of the optical beam with a predetermined upper limit value;
a lower limit value comparing unit that compares the intensity signal with a predetermined lower limit value smaller than the upper limit value; and
an output value control unit that decreases an output value for controlling the output intensity of the optical beam from the output value immediately before when the intensity signal is larger than the upper limit value, increasing the output value from the output value immediately before when the intensity signal is smaller than the lower limit value, and holds the output value as the output value immediately before when the intensity signal is smaller than the upper limit value and larger than the lower limit value.

15. An optical disk device for controlling an output intensity of an optical beam emitted on an optical disk when data is written to the optical disk or data is read from the optical disk, comprising:
a light receiving unit that receives an optical beam and generates an intensity signal according to an intensity of the optical beam;
an upper limit value comparing unit that compares the intensity signal with a predetermined upper limit value;
a lower limit vale comparing unit that compares the intensity signal with the predetermined lower limit value smaller than the upper limit value;
an output value control unit that decreases an output value for controlling the output intensity of the optical beam from the output value immediately before when the intensity signal is larger than the upper limit value, increases the output value from the output value immediately before when the intensity signal is smaller than the lower limit value, and holding the output value as the output value immediately before when the intensity signal is smaller than the upper limit value and larger than the lower limit value; and
an optical beam output unit that regulates the output intensity based on the output value to output the optical beam.
